(19) United States
(12) Patent Application Publication
(10) Pub. No.: US 2006/0200656 A1
(43) Pub. Date: Sep. 7, 2006

(54) Apparatus and method to capture data from an embedded device

(76) Inventors: Charles Scott Cardinell, Tucson, AZ (US); Marcus S. Cooper, Tucson, AZ (US); Roger G. Hathorn, Tucson, AZ (US)

Correspondence Address: DALE F. REGELMAN, 4231 S. FREMONT AVENUE, TUCSON, AZ, 85714, US

(21) Appl. No.: 11/073,244

(22) Filed: Mar. 3, 2005

(51) Int. Cl. G06F 15/177; G06F 9/00; G06F 9/24

(52) U.S. Cl. 713/2; 713/1

(57) ABSTRACT

A method is disclosed to capture data from an embedded device. The method provides an embedded device comprising a processor, memory, and microcode, where the microcode specifies a first fixed address in the memory. The method creates a Registry at the first fixed address, and populates the Registry with a plurality of entries, where each of those entries comprises an address and a data length describing one or more data regions of the memory. The method then performs an LRC check on the Registry, and saves the LRC information to the Registry. If the embedded device fails, the method downloads the Registry, and the data regions described by the Registry for embedded device failure analysis.

### FIELD OF THE INVENTION

This invention relates to an apparatus and method to capture data from an embedded device. In certain embodiments, the invention relates to capturing data from a failed adapter disposed in an information storage and retrieval system.

### BACKGROUND OF THE INVENTION

Embedded devices comprise special purposes devices requiring high performance but having relatively few dedicated resources. For example, embedded devices typically comprise a memory, a processor, few if any standard utilities, and no hard disks.

In addition, embedded devices typically do not comprise a conventional operating system. A conventional operating system is written for flexibility. An embedded system, however, performs a dedicated purpose. Therefore, such an embedded device operates using a device microcode written to optimize the device's dedicated function.

If an embedded device fails and cannot collect information for an error analysis due to nature of the failure, the contents of the memory on the adapter must be accessed. With the amount of memory disposed on an adapter ever increasing, it is impractical to download all that memory to assist in device recovery and/or performing a failure analysis.

Prior art methods either capture all the memory disposed in the failed adapter, or select certain address ranges of that memory for data capture. The first approach is undesirable because of the time required to off-load all the adapter memory when only a portion of that memory is pertinent to a failure analysis. The second approach is troublesome because it is often difficult, or impossible, to determine the location of the pertinent memory because data locations may change with different versions of the device microcode or software running the embedded device.

Applicants' apparatus and method includes a registry function that keeps track of the addresses and data lengths of information pertinent to an analysis of embedded device failure. These pertinent addresses and data lengths are written to a Registry in the device memory, where that Registry is copied to a different, remote portion of the device memory.

### SUMMARY OF THE INVENTION

Applicants' invention includes an apparatus and method to capture data from an embedded device. The method provides an embedded device comprising a processor, memory, and microcode, where the microcode specifies a first fixed address in the memory and a second fixed address in the memory, where the first fixed address differs from the second fixed address. The method creates a Registry at the first fixed address, and populates the Registry with a plurality of entries, where each of those entries comprises an address and a data length. The method then performs an LRC check on the Registry, and saves the LRC information to the Registry. If the embedded device fails, the method downloads the registry and the data regions described by the Registry entries for failure analysis.

### BRIEF DESCRIPTION OF THE DRAWINGS

The invention will be better understood from a reading of the following detailed description taken in conjunction with the drawings in which like reference designators are used to designate like elements, and in which:

FIG. 1 is a block diagram showing one embodiment of Applicants' information storage and retrieval system;

FIG. 2 is a block diagram showing Applicants' Registry;

FIG. 3 is a flow chart summarizing the steps of Applicants' method to create and populate Applicants' Registry;

FIG. 4 is a block diagram showing the address and data length of one entry in Applicants' Registry;

FIG. 5 is a block diagram showing the address and data length for an existing Registry entry and for a new entry, wherein the new entry completely includes the existing Registry entry;

FIG. 6A is a block diagram showing an overlapping existing Registry entry and a new entry;

FIG. 6B is a block diagram showing an expanded existing Registry entry to include both the existing Registry entry and the new entry of FIG. 6A;

FIG. 7 is a flow chart summarizing certain additional steps of Applicants' method to populate the Registry;

FIG. 8 is a block diagram showing the components of a typical embedded device;

FIG. 9 is a flow chart summarizing the steps of Applicants' method to use the Registry to facilitate failed device recovery analysis.

### DETAILED DESCRIPTION OF THE PREFERRED EMBODIMENTS

This invention is described in preferred embodiments in the following description with reference to the Figures, in which like numbers represent the same or similar elements. Applicants' invention is described herein in embodiments wherein the embedded device comprises an adapter disposed in an information storage and retrieval system. The following description of Applicant's method to capture data from an embedded device is not meant, however, to limit Applicant's invention to data processing applications, as Applicants' method can be applied generally to capturing data from an embedded device.

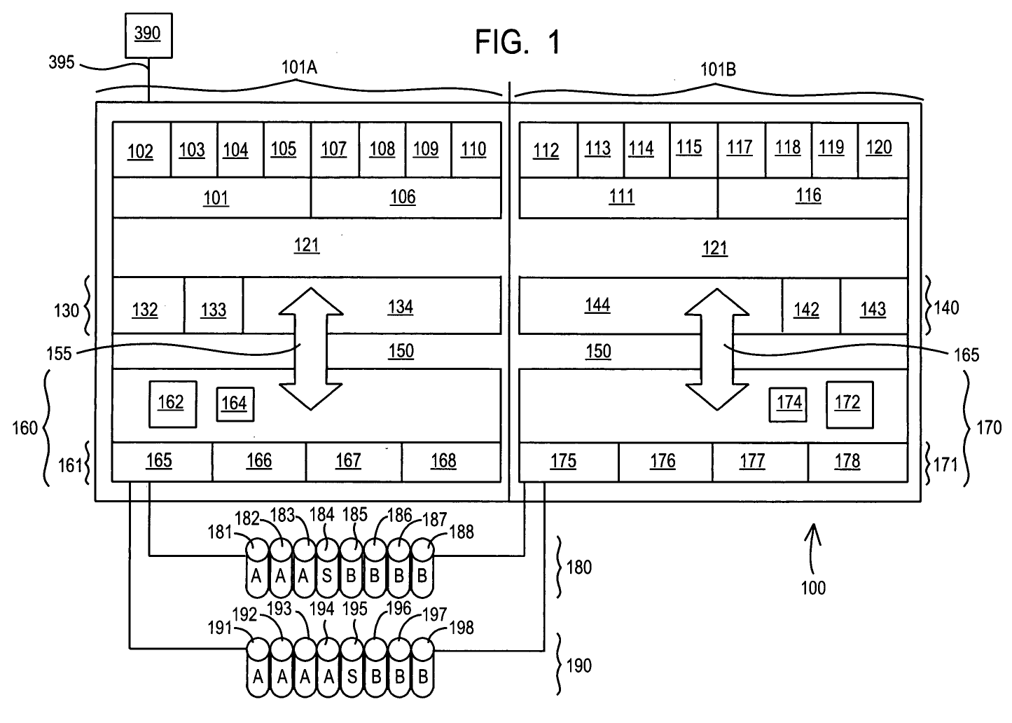

Referring now to FIG. 1, information storage and retrieval system 100 is capable of communication with host computer 390 via communication link 395. The illustrated embodiment of FIG. 1 shows a single host computer. In other embodiments, Applicants' information storage and retrieval system is capable of communicating with a plurality of host computers.

Host computer 390 comprises a computer system, such as a mainframe, personal computer, workstation, and combinations thereof, including an operating system such as Windows, AIX, Unix, MVS, LINUX, etc. (Windows is a registered trademark of Microsoft Corporation; AIX is a registered trademark and MVS is a trademark of IBM Corporation; and UNIX is a registered trademark in the United States and other countries licensed exclusively through The Open Group.) In certain embodiments, host computer 390 further includes a storage management program. The storage management program in the host computer 390 may include the functionality of storage management type programs known in the art that manage the transfer of data to a data storage and retrieval system, such as the IBM DFSMS implemented in the IBM MVS operating system.

In certain embodiments, Applicants' information storage and retrieval system 100 includes a plurality of host adapters 102-105, 107-110, 112-115, and 117-120, disposed in four host bays 101, 106, 111, and 116. In other embodiments, Applicants' information storage and retrieval system includes fewer than 16 host adapters. In still other embodiments, Applicants' information storage and retrieval system includes more than 16 host adapters.

Regardless of the number of host adapters disposed in any embodiments of Applicants' system, each of those host adapters comprises a shared resource that has equal access to both central processing/cache elements 130 and 140. Each host adapter may comprise one or more Fibre Channel ports, one or more FICON ports, one or more ESCON ports, or one or more SCSI ports. Each host adapter is connected to both clusters through interconnect bus 121 such that each cluster can handle I/O from any host adapter.

Processor portion 130 includes processor 132 and cache 134. In certain embodiments, processor portion 130 further includes memory 133. In certain embodiments, memory device 133 comprises random access memory. In certain embodiments, memory device 133 comprises non-volatile memory.

Processor portion 140 includes processor 142 and cache 144. In certain embodiments, processor portion 140 further includes memory 143. In certain embodiments, memory device 143 comprises random access memory. In certain embodiments, memory device 143 comprises non-volatile memory.

I/O portion 160 comprises a plurality of device adapters, such as device adapters 165, 166, 167, and 168. I/O portion 170 further comprises a plurality of device adapters, such as device adapters 175, 176, 177, and 178.

In certain embodiments of Applicants' system, one or more host adapters, processor portion 130, and one or more device adapters, are packaged together on a single card disposed in Applicants' information storage and retrieval system. Similarly, in certain embodiments, one or more host adapters, processor portion 160, and one or more device adapters, are disposed on another card disposed in Applicants' information storage and retrieval system. In these embodiments, Applicants' system 100 includes two cards interconnected with a plurality of data storage devices.

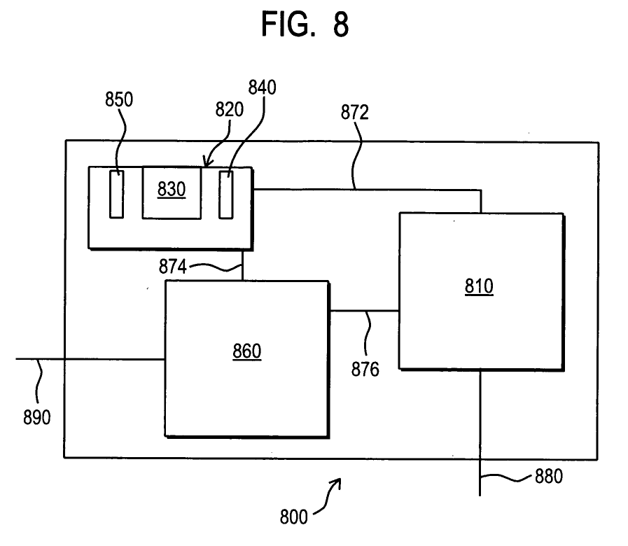

FIG. 8 shows a block diagram of a typical embedded device 800. Device 800 includes a processor 810, memory 820, and a control chip 860. Memory 820 is interconnected with processor via bus 872 and with control chip 860 via bus 874. Processor 810 is interconnected with control chip 860 via bus 876. Processor 810 is interconnected with one or more external devices via communication link 880, and control chip 860 is interconnected with one or more external devices via communication link 890.

As those skilled in the art will appreciate, many embedded devices comprise other components in addition to the components shown in FIG. 8. As those skilled in the art will further appreciate, an embedded device may further comprise a plurality of chips. As those skilled in the art will further appreciate, chip 860 may comprise an ASIC, a LSI circuit, a VLSI circuit, and the like.

In the illustrated embodiment of FIG. 8, instructions/functions 830 are written to memory 820. In certain embodiments, instructions/functions 830 comprises device microcode, wherein processor 810 utilizes microcode 830 to operate embedded device 800. In other embodiments, instructions/functions 830 comprise an operating system, wherein processor 810 utilizes operating system 830 to operate device 800.

In the illustrated embodiment of FIG. 8, memory 820 further includes Registry 840 written to a first fixed address in device memory, wherein the structure and function of that Registry are described below. In the illustrated embodiment of FIG. 8, memory 820 further includes Registry Copy 850 written to a second fixed address in device memory, wherein the first fixed address differs from the second fixed address.

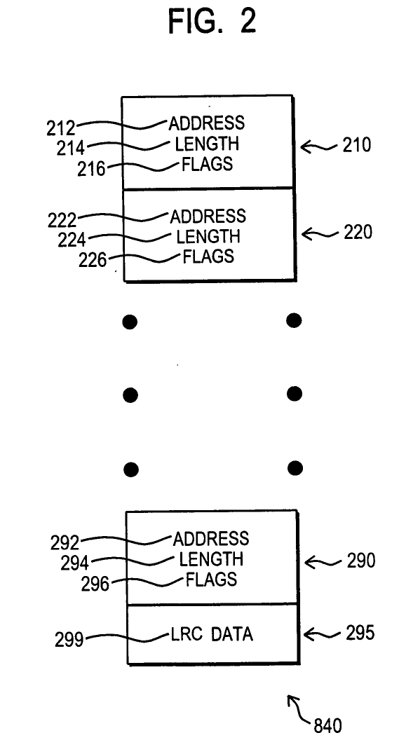

FIG. 2 shows a block diagram of Registry 840. Referring now to FIG. 2, Registry 840 includes a plurality of entries. For sake of illustration, FIG. 2 only shows three entries, namely entry 210, entry 220, and entry 290. Each of the entries includes the address of the data, such as for example addresses 212, 222, and 292, and the length of the data to be saved, such as for example data lengths 214, 224, and 294. Optionally, an entry may include one or more flags, such as flags 216, 226, and 296, where those flags comprise control information.

Registry 840 further includes LRC information created using a longitudinal redundancy check (“LRC”) of Registry 840. Upon revising one or more existing Registry entries, or adding a new entry, an LRC check is performed on the entire Registry 840, and the resulting LRC information is stored in Registry portion 295.

In certain embodiments, a duplicate copy of the Registry is formed and saved in a different location in the device memory, i.e. at a second fixed address. Applicants have found that it is unlikely that a single failure or a coding error will cause both copies of the Registry to become corrupt.

In certain embodiments, the embedded device comprises a component, such as for example a host adapter or a device adapter, disposed in Applicants' information storage and retrieval system which comprise one or more system memories. In certain of embodiments of Applicants' method, a copy of Registry 840 is also saved to system memory, such as for example memory 133 (FIG. 1) and/or memory 143 (FIG. 1).

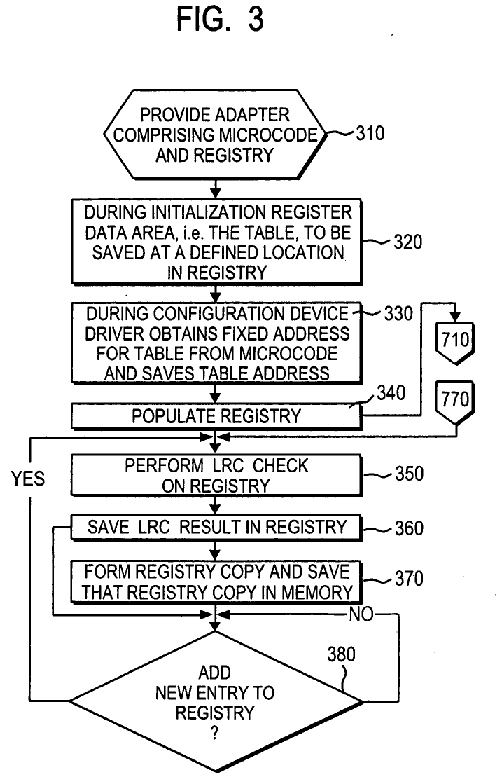

FIG. 3 summarizes the steps in Applicants' method to create and populate Applicants' Registry. The steps 320 through 380 are performed by the device processor using the device microcode. Referring now to FIG. 3, in step 310 Applicants' method provides an embedded device comprising microcode, such as microcode 830 (FIG. 8), a processor, such as processor 810 (FIG. 8), and memory, such as memory 820 (FIG. 8). In certain embodiments, memory 820 comprises battery back-up RAM. In certain embodiments, memory 820 comprises a hard disk drive device. In certain embodiments, memory 820 comprises electronic storage medium, such as a device such as a PROM, EPROM, EEPROM, Flash PROM, compactflash, smartmedia, and the like.

In step 320, during device initialization Registry 840 is registered, where that Registry will be saved at a first fixed address in the device memory. In step 330, during configuration a device driver obtains from the microcode that first fixed address for the Registry. Step 330 further includes writing the Registry to that first fixed address.

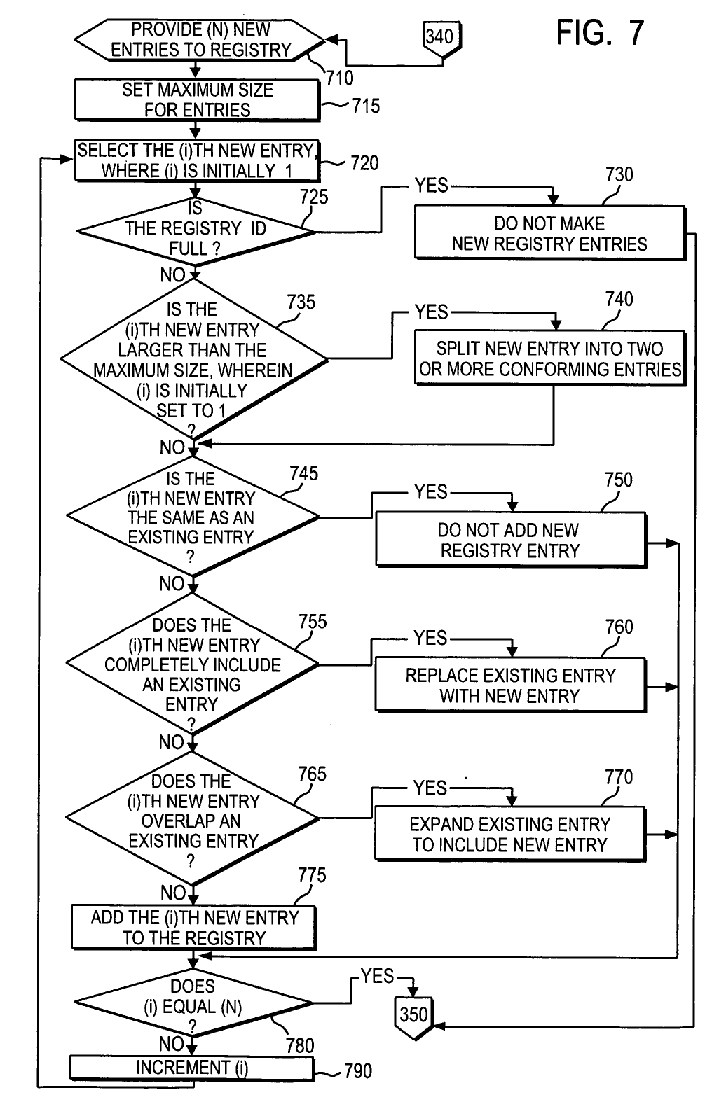

In step 340, the Registry is populated. In certain embodiments, step 340 includes the steps recited in FIG. 7. In certain embodiments, step 340 is performed as the flash runs. In step 350, and after the Registry has been populated, Applicants' method performs a longitudinal redundancy check of the data regions described in the newly-populated Registry. In step 360, Applicants' method saves in the Registry, such as Registry portion 895, the LRC information generated in step 350.

In certain embodiments, Applicants' method transitions from step 360 to step 380. In other embodiments, Applicants' method includes step 370, such that the method transitions from step 360 to step 370. In step 370, Applicants' method forms a copy of the Registry, such as Registry Copy 850, and saves that Registry Copy at a second fixed address in the device memory. In certain embodiments, step 370 further includes saving a Registry Copy in the system memory, such as memory 133 (FIG. 1) and/or memory 143 (FIG. 1). In certain embodiments, a Registry Copy is saved in both device memory and in system memory.

Applicants' method transitions from step 370 to step 380 wherein the method determines if a new entry has been added to the Registry. If a new entry is added to the Registry, then Applicants' method transitions from step 380 to step 350 and continues as described herein. Alternatively, if no new entry has been added, Applicants' method continues to monitor for new a new Registry entry in step 380.

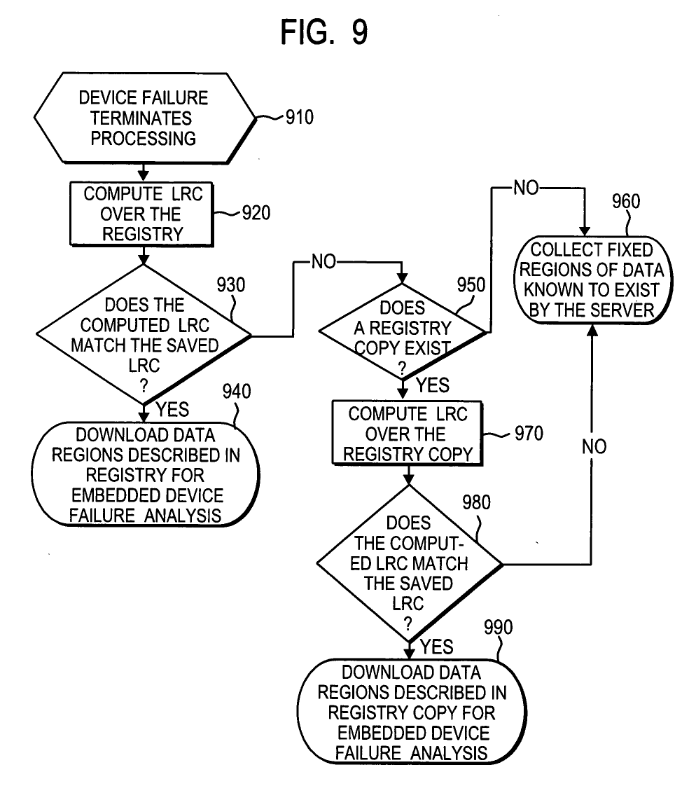

FIG. 9 summarizes the steps in Applicants' method to utilize the Registry formed in step 340, and/or the Registry Copy formed in step 370, to facilitate embedded device failure analysis. The steps of FIG. 9 are performed by a processor disposed in the system which comprises the embedded device, such as information storage and retrieval system 100 and/or one or more host computers in communication with system 100.

Referring now to FIG. 9, in step 910, a failure of the embedded device terminates device processing. In certain embodiments, step 910 includes a device failure wherein the embedded device cannot undertake a recovery process which includes saving traces and data structures for later failure analysis.

In step 920, the system comprising the embedded device, such as information storage and retrieval system 100, downloads the Registry, and computes the LRC over the downloaded Registry. In step 930, a system processor determines if the computed LRC information of step 920 matches the previously saved LRC information of step 350.

If Applicants' method determines in step 930 that the computed LRC information matches the saved LRC information, then the method transitions from step 930 to step 940 wherein the system uses the Registry to download the data regions described by the registry entries for device recovery and/or failure analysis (collectively “embedded device failure analysis”).

Alternatively, if the system processor determines in step 930 that the computed LRC of step 920 does not match the saved LRC of step 350, then the method transitions from step 930 to step 950 wherein Applicants' method determines if a Registry Copy was saved in step 370.

If Applicants' method determines in step 950 that a Registry Copy was not formed and saved in step 370, then the method transitions from step 950 to step 960 wherein a system processor collects fixed regions of data known to exist for use in embedded device failure analysis. Alternatively, if Applicants' method determines in step 950 that a Registry Copy was formed and saved in step 370, then the method transitions from step 950 to step 970 wherein the system processor downloads the Registry Copy, and computes the LRC over the downloaded Registry Copy. In step 980, a system processor determines if the computed LRC information of step 970 matches the previously saved LRC information of step 360.

If Applicants' method determines in step 980 that the computed LRC information matches the saved LRC information, then the method transitions from step 980 to step 990 wherein the system comprising the embedded device downloads the data regions described by the registry entries in the Registry Copy for embedded device failure analysis. If Applicants' method determines in step 980 that the computed LRC information does not match the saved LRC information, then the method transitions from step 980 to step 960 wherein a system processor collects fixed regions of data known to exist for use in embedded device failure analysis.

In certain embodiments of Applicants' method, step 324 includes the steps recited in FIG. 7. In certain embodiments of Applicants' method, revisions to one or more existing entries of the Registry and/or addition of one or more new entries to the Registry, are performed using the steps recited in FIG. 7. Steps 715, 720, 725, 730, 735, 740, 745, 750, 755, 760, 765, 770, 775, 780, and 790, of FIG. 7 are performed by a processor disposed in the embedded device using microcode disposed in that embedded device.

Referring now to FIG. 7, in step 710 the method provides, and the embedded device receives, (N) new entries for the Registry. In certain embodiments, the (N) new entries are provided during device initialization and configuration, i.e. Applicants' method transitions from step 320 to step 710. In other embodiments, the (N) new entries are provided in step 380.

In step 715, Applicants' method sets a maximum size for Registry entries. For example in certain embodiments, if the buffer size in the system which comprises the embedded device is limited to 10 megabytes, then Applicants' method in step 715 sets the maximum size for Registry entries at 10 megabytes. In certain embodiments, the maximum size of step 715 is encoded in device microcode. In certain embodiments, step 715 is performed at device initialization.

In step 720, Applicants' method selects the (i)th new entry, wherein (i) is initially set to 1. In step 725, Applicants' method determines if the Registry ID is full. If Applicants' method determines in step 725 that the Registry ID is full, then the method transitions from step 725 to step 730 wherein the method does not make a new Registry entry. Applicants' method transitions from step 730 to step 350 and continues as described herein.

If Applicants' method determines in step 725 that the Registry ID is not full, then the method transitions from step 725 to step 735 wherein the method determines if the (i)th new entry is larger than the maximum size of step 715. If the device processor determines in step 735 that the (i)th new entry is larger than the maximum size of step 715, then the method transitions from step 735 to step 740 wherein the device processor splits the (i)th new entry into two or more conforming new entries, increments (N) as needed, designates one of the newly-formed smaller entries as the (i)th new entry, and transitions to step 745 wherein the device processor determines if the (i)th new entry is attempting to register an existing Registry entry.

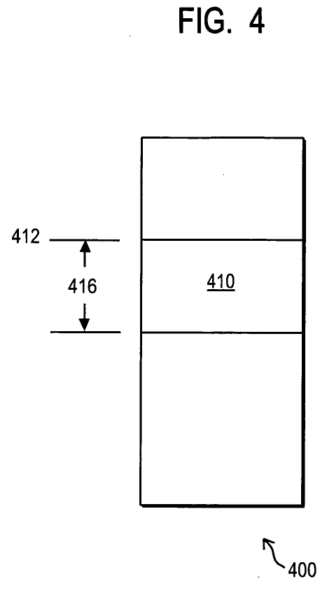

For example and referring to FIG. 4, if an existing Registry entry registers data 410 having address 412 and data length 416, and if the (i)th new entry is attempting to register data 410 having address 412 and data length 416, then Applicants' method determines in step 745 that the (i)th new entry is attempting to register an already-existing Registry entry. If the device processor determines in step 745 that the (i)th new entry is attempting to register data having an address 412 and a data length less than data length 416, then Applicants' method determines that the (i)th new entry is attempting to register an existing Registry entry.

If Applicants' method determines in step 745 that the (i)th new entry is attempting to register an existing Registry entry, then the method transitions from step 745 to step 750 wherein the method does not add the (i)th new entry to the Registry. Applicants' method transitions from step 750 to step 780.

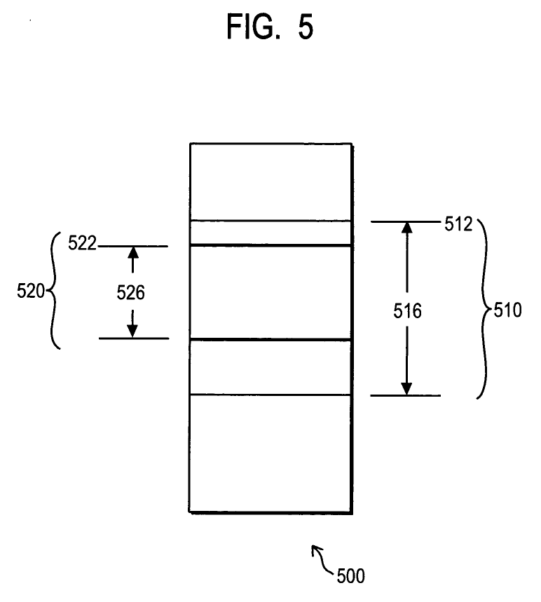

If the device processor determines in step 745 that the (i)th new entry is not attempting to register an already existing Registry entry, then the method transitions from step 745 to step 755 wherein the device processor determines if the (i)th new entry completely includes an existing Registry entry. For example and referring to FIG. 5, if an existing Registry entry registers data 520 having address 522 and a data length of 526, and the (i)th new entry is attempting to register data 510 having address 512 and data length 516 wherein data length 526 lies completely within data length 516, the Applicants' method determines in step 755 that the (i)th new entry completely includes an existing Registry entry.

If the device processor determines in step 755 that the (i)th new entry completely includes an existing Registry entry, then the method transitions from step 755 to step 760 wherein the method replaces the existing Registry entry with the (i)th new entry. Applicants' method transitions from step 760 to step 780.

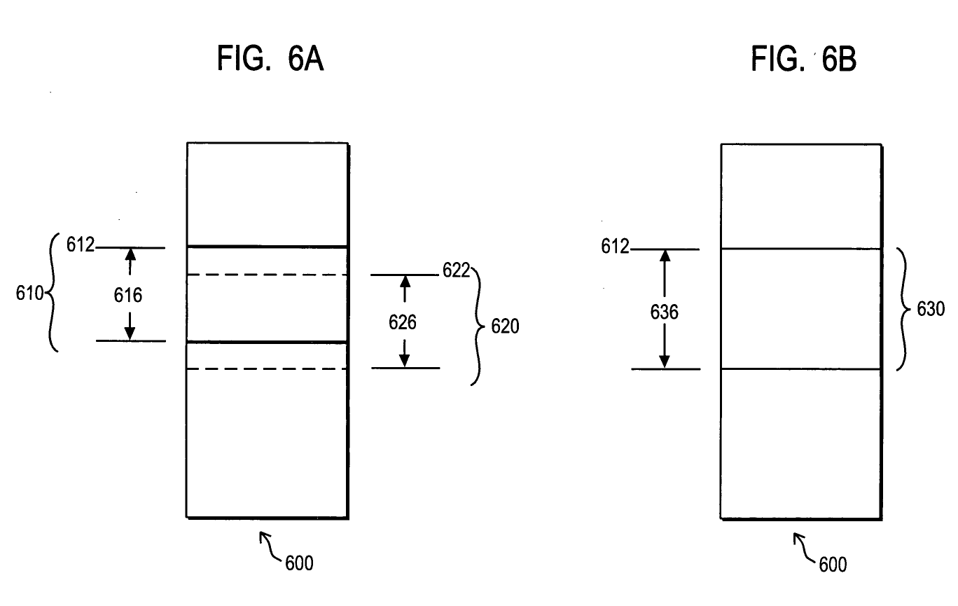

If the device processor determines in step 755 that the (i)th new entry does not completely include an existing Registry entry, then the method transitions from step 755 to step 765 wherein the device processor determines if the (i)th new entry overlaps an existing Registry entry. For example and referring to FIG. 6A, if an existing Registry entry registers data 610 which has address 612 and data length 616 and the (i)th new entry is attempting to register data 620 having address 622 and data length 626, wherein data length 616 includes some but not all of data length 626, then Applicants' method determines that the (i)th new entry overlaps an existing Registry entry.

If the device processor determines in step 765 that the (i)th new entry overlaps an existing Registry entry, then the method transitions from step 765 to step 770 wherein the device processor expands the existing Registry entry to include the (i)th new entry. For example and referring now to FIGS. 6A and 6B, in step 750 Applicants' method would determine that the (i)th new entry attempting to register data 620 overlaps the existing Registry entry which registers data 610. In step 770, Applicants' method expands the existing Registry entry to register data 630 having address 612 and data length 636.

If the device processor determines in step 765 that the (i)th new entry does not overlap an existing Registry entry, then the method transitions from step 765 to step 775 wherein the device processor adds the (i) new entry to the Registry. Applicants' method transitions from step 775 to step 780 wherein the device processor determines if all the new entries have been examined, i.e. if (i) equals (N).

If the device processor determines in step 780 that (i) equals (N), then the method transitions from step 780 to step 350 and continues as described herein. Alternatively, if the device processor determines in step 780 that (i) does not equal (N), then the method transitions from step 780 to step 790 wherein the device processor increments (i). Applicants' method transitions from step 790 to step 720 and continues as described herein.

In certain embodiments, individual steps recited in FIGS. 3, and/or 7, and/or 9 may be combined, eliminated, or reordered.

In certain embodiments, Applicants' invention includes instructions residing in the memory, such as memory 820 and/or memory 133 (FIG. 1) and/or memory 143 (FIG. 1), where those instructions are executed by the device processor, such as processor 810 (FIG. 8), and/or the system processor 132 (FIG. 1) and/or 142 (FIG. 1), to perform one or more of steps 310 through 380, recited in FIG. 3, and/or to perform one or more of steps 710 through 790, recited in FIG. 7, and/or to perform one or more of steps 920 through 990 recited in FIG. 9.

In other embodiments, Applicants' invention includes instructions residing in any other computer program product, where those instructions are executed by a computer external to, or internal to, system 100, to perform one or more of steps 310 through 380, recited in FIG. 3, and/or to perform one or more of steps 710 through 790, recited in FIG. 7, and/or to perform one or more of steps 920 through 990 recited in FIG. 9. In either case, the instructions may be encoded in an information storage medium comprising, for example, a magnetic information storage medium, an optical information storage medium, an electronic information storage medium, and the like. By “electronic storage medium,” Applicants mean, for example, a device such as a PROM, EPROM, EEPROM, Flash PROM, compactflash, smartmedia, and the like.

While the preferred embodiments of the present invention have been illustrated in detail, it should be apparent that modifications and adaptations to those embodiments may occur to one skilled in the art without departing from the scope of the present invention as set forth in the following claims.

We claim:

1. A method to capture data from an embedded device, comprising the steps of:
providing an embedded device comprising a processor, memory, and microcode, wherein said microcode specifies a first fixed address in said memory;
saving a Registry at said first fixed address;
populating said Registry with a plurality of entries, wherein each of said entries comprises an address and a data length, and wherein each of said entries describes one or more data regions in said memory;
performing an LRC check on said Registry to form first LRC information;
saving said first LRC information to said Registry.

2. The method of claim 1, further comprising the step of populating said Registry with a plurality of entries, wherein one or more of said entries comprises one or more control flags.

3. The method of claim 1, further comprising the steps of:
operative if said embedded device fails, downloading the Registry;
reading said first LRC information from said downloaded Registry;
computing an LRC check on said downloaded Registry to form second LRC information;
determining if said first LRC information matches said second LRC information;
operative if said first LRC information matches said second LRC information, downloading the data regions described by said Registry entries.

4. The method of claim 3, wherein said microcode further specifies a second fixed address in said memory, wherein said first fixed address differs from said second fixed address, further comprising the following steps:
forming a Registry Copy comprising a plurality of entries, wherein each of said entries comprises an address and a data length, and wherein each of said entries describes one or more data regions in said memory;
saving said Registry Copy in said memory at said second fixed address;
computing an LRC check on said Registry Copy to form third LRC information;
saving said third LRC information to said Registry Copy;
operative if said first LRC information do not match said second LRC information, downloading said Registry Copy.

5. The method of claim 4, further comprising the steps of:
computing an LRC check on said downloaded data Registry Copy to form fourth LRC information;
determining if said third LRC information matches said fourth LRC information;
operative if said third computed LRC information matches said fourth LRC information, downloading the data regions described by said plurality of entries in said Registry Copy.

6. The method of claim 1, wherein said embedded device comprises an adapter disposed in an information storage and retrieval system comprising a system memory, further comprising the step of saving said Registry Copy in said system memory.

7. The method of claim 1, further comprising the steps of:
setting a maximum size for Registry entries;
providing a new entry;
determining if said new entry is larger than said maximum size;
operative if said new entry is larger than said maximum size, splitting said new entry into two or more entries each of which is not larger than said maximum size.

8. The method of claim 7, further comprising the steps of:
determining if said new entry is the same as an existing Registry entry;
operative if said new entry is the same as an existing Registry entry, not adding said new entry to said Registry.

9. The method of claim 8, further comprising the steps of:
determining if said new entry completely includes an existing Registry entry;
operative if said new entry completely includes an existing Registry entry, replacing said existing Registry entry with said new entry.

10. The method of claim 9, further comprising the steps of:
determining if said new entry overlaps an existing Registry entry;
operative if said new entry overlaps an existing Registry entry, expanding said existing Registry entry to include said new entry.

11. An information storage and retrieval system comprising an embedded device comprising a processor, device memory and microcode, wherein said microcode specifies a first fixed address in said device memory, said information storage and retrieval system further comprising a computer useable medium having computer readable program code disposed therein to capture data from said device memory, the computer readable program code comprising a series of computer readable program steps to effect:
providing an embedded device comprising a processor, memory, and microcode, wherein said microcode specifies a first fixed address in said memory;
saving a Registry at said first fixed address;
populating said Registry with a plurality of entries, wherein each of said entries comprises an address and a data length, and wherein each of said entries describes one or more data regions in said memory;
performing an LRC check on said Registry to form first LRC information;
saving said first LRC information to said Registry.

12. The information storage and retrieval system of claim 11, said computer readable program code further comprising a series of computer readable program steps to effect populating said Registry with a plurality of entries, wherein one or more of said entries comprises one or more control flags.

13. The information storage and retrieval system of claim 11, said computer readable program code further comprising a series of computer readable program steps to effect:
operative if said embedded device fails, downloading said Registry;
reading said first LRC information from said downloaded Registry;
computing an LRC check on said downloaded Registry to form second LRC information;
determining if said first LRC information matches said second LRC information;
operative if said first LRC information matches said second LRC information, downloading the data regions described by said Registry entries.

14. The information storage and retrieval system of claim 13, wherein said microcode further specifies a second fixed address in said memory, wherein said first fixed address differs from said second fixed address, said computer readable program code further comprising a series of computer readable program steps to effect:
forming a Registry Copy comprising a plurality of entries, wherein each of said entries comprises an address and a data length, and wherein each of said entries describes one or more data regions in said memory;
saving said Registry Copy in said memory at said second fixed address;
computing an LRC check on said Registry Copy to form third LRC information;
saving said third LRC information to said Registry Copy;
operative if said first LRC information do not match said second LRC information, downloading said Registry Copy.

15. The information storage and retrieval system of claim 14, said computer readable program code further comprising a series of computer readable program steps to effect:
computing an LRC check on said downloaded Registry Copy to form fourth LRC information;
determining if said third LRC information matches said fourth LRC information;
operative if said third LRC information matches said fourth LRC information, downloading the data regions data regions described by said plurality of entries in said Registry Copy.

16. The information storage and retrieval system of claim 11, wherein said information storage and retrieval system further comprises a system memory, said computer readable program code further comprising a series of computer readable program steps to effect saving said Registry Copy in said system memory.

17. The information storage and retrieval system of claim 11, said computer readable program code further comprising a series of computer readable program steps to effect:
retrieving a maximum size for Registry entries;
receiving a new entry;
determining if said new entry is larger than said maximum size;
operative if said new entry is larger than said maximum size, splitting said new entry into two or more entries each of which is not larger than said maximum size.

18. The information storage and retrieval system of claim 17, said computer readable program code further comprising a series of computer readable program steps to effect:
determining if said new entry is the same as an existing Registry entry;
operative if said new entry is the same as an existing Registry entry, not adding said new entry to said Registry.

19. The information storage and retrieval system of claim 18, said computer readable program code further comprising a series of computer readable program steps to effect:
determining if said new entry completely includes an existing Registry entry;
operative if said new entry completely includes an existing Registry entry, replacing said existing Registry entry with said new entry.

20. The information storage and retrieval system of claim 19, said computer readable program code further comprising a series of computer readable program steps to effect:
determining if said new entry overlaps an existing Registry entry;
operative if said new entry overlaps an existing Registry entry, expanding said existing Registry entry to include said new entry.

21. A computer program product usable with a programmable computer processor to capture data from an embedded device comprising a processor, device memory and microcode, wherein said microcode specifies a first fixed address in said device memory, comprising:
computer readable program code which causes said programmable computer processor to save a Registry at said first fixed address;
computer readable program code which causes said programmable computer processor to populate said Registry with a plurality of entries, wherein each of said entries comprises an address and a data length, and wherein each of said entries describes one or more data regions in said memory;
computer readable program code which causes said programmable computer processor to perform an LRC check on said Registry to form first LRC information;
computer readable program code which causes said programmable computer processor to save said first LRC information to said Registry.

22. The computer program product of claim 21 further comprising:
computer readable program code which causes said programmable computer processor to populate said Registry with a plurality of entries, wherein one or more of said entries comprises one or more control flags.

23. The computer program product of claim 21, further comprising:
computer readable program code which, if said embedded device fails, causes said programmable computer processor to said Registry;
computer readable program code which causes said programmable computer processor to read said first LRC information from said downloaded Registry;
computer readable program code which causes said programmable computer processor to compute an LRC check on said downloaded Registry to form second LRC information;
computer readable program code which causes said programmable computer processor to determine if said first LRC information matches said second LRC information;
computer readable program code which, if said first LRC information matches said second LRC information, causes said programmable computer processor to download the data regions described by said Registry entries.

24. The computer program product of claim 23, wherein said microcode further specifies a second fixed address in said memory, wherein said first fixed address differs from said second fixed address, further comprising:
computer readable program code which causes said programmable computer processor to form a Registry Copy comprising a plurality of entries, wherein each of said entries comprises an address and a data length, and wherein each of said entries describes one or more data regions in said memory;
computer readable program code which causes said programmable computer processor to save said Registry Copy in said memory at said second fixed address;
computer readable program code which causes said programmable computer processor to compute an LRC check on said Registry Copy to form third LRC information;
computer readable program code which causes said programmable computer processor to save said third LRC information to said Registry Copy;
computer readable program code which, if said first LRC information does not match said second LRC information, causes said programmable computer processor to download said Registry Copy.

25. The computer program product of claim 24, further comprising:
computer readable program code which causes said programmable computer processor to compute an LRC check on said downloaded Registry Copy to form fourth LRC information;
computer readable program code which causes said programmable computer processor to determine if said third LRC information matches said fourth LRC information;
computer readable program code which, if said third computed LRC information matches said fourth LRC information, causes said programmable computer processor to download the data regions data regions described by said plurality of entries in said Registry Copy.

26. The computer program product of claim 21, wherein said information storage and retrieval system further comprises a system memory, further comprising computer readable program code which causes said programmable computer processor to save said Registry Copy in said system memory.

27. The computer program product of claim 21, further comprising:
computer readable program code which causes said programmable computer processor to retrieve a maximum size for Registry entries;
computer readable program code which causes said programmable computer processor to receive a new entry;
computer readable program code which causes said programmable computer processor to determine if said new entry is larger than said maximum size;
computer readable program code which, if said new entry is larger than said maximum size, causes said programmable computer processor to split said new entry into two or more entries each of which is not larger than said maximum size.

28. The computer program product of claim 27, further comprising:
computer readable program code which causes said programmable computer processor to determine if said new entry is the same as an existing Registry entry;
computer readable program code which, if said new entry is the same as an existing Registry entry, causes said programmable computer processor to operative not adding said new entry to said Registry.

29. The computer program product of claim 28, further comprising:
computer readable program code which causes said programmable computer processor to determine if said new entry completely includes an existing Registry entry;
computer readable program code which, if said new entry completely includes an existing Registry entry, causes said programmable computer processor to replace said existing Registry entry with said new entry.

30. The computer program product of claim 29, further comprising:
computer readable program code which causes said programmable computer processor to determining if said new entry overlaps an existing Registry entry;
computer readable program code which, if said new entry overlaps an existing Registry entry, causes said programmable computer processor to expand said existing Registry entry to include said new entry.
